(19) United States
(12) Patent Application Publication
(10) Pub. No.: US 2009/0025851 A1
(43) Pub. Date: Jan. 29, 2009

(54) Use of Compositions for Removing Silicone Compounds

(75) Inventor: Wolf-Rudiger Huck, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 11/922,914

(22) PCT Filed: Jun. 30, 2006
(86) PCT No.: PCT/EP2006/063710

§ 371 Date: Dec. 27, 2007

(30) Foreign Application Priority Data
Jun. 30, 2005 (EP) 05105954.1

(51) Int. Cl. B32B 37/12; C11D 3/08

(52) U.S. Cl. 156/60; 510/181

(57) ABSTRACT

A method for cleaning the surfaces of panes, in particular to remove silicone compounds from the surface of panes including a composition with at least one carrier and at least one silicic acid and/or at least one silicate. The composition additionally can include at least one adhesion promoter composition. A method for using such compositions to efficiently remove silicone compounds from glass or glass ceramic surfaces without damaging the glass or glass ceramic surface. A method of cleaning a surface prior to bonding the surface with a second surface. A composition with at least one solvent, at least one adhesion promoter substance, at least one substance selected from among the group consisting of silicic acid and/or silicate and at least one additive.

### TECHNICAL FIELD

The invention relates to the field of cleaning panes, especially in automotive assembly and automotive repair. The invention relates to use of a composition including at least one carrier and at least one silicic acid and/or at least one silicate for removal of silicone compounds on a glass or glass ceramic surface.

### PRIOR ART

In bonding a pane to a substrate, contaminants on glass panes is a major problem. In particular, residues of lubricants and oils or silicone compounds on glass panes, which often appear during the manufacturing process or during transport of the panes, can lead to defective bonding since adhesives do not adhere to silicone-like contaminants or to an oily surface.

A number of cleaning agents and cleaning methods are used to remove contaminants from panes. These include, for example, solvents such as alcohols or aqueous compositions with surfactants. However, such solvents are not suitable for dissolving silicone-containing contaminants or oils. Therefore stronger solvents such as, for example, aliphatic solvents, aromatics, or ketones are used. But in many cases, cleaning agents based on such solvents are undesirable for occupational hygiene and safety reasons. Solvents are also not suitable for reliably removing silicone compounds. Physical or physicochemical cleaning methods are also known in the prior art.

These include in particular various plasma treatments, treatment with dry ice, or treatment with abrasives such as, for example, in the Scotch-Brite™ series, commercially available from 3M™. But all these methods have significant disadvantages. For example, plasma treatment is very labor-intensive and expensive and non-portable, since the plasma apparatus is generally installed in a fixed location. Dry ice treatment is likewise very expensive. In addition, the considerable temperature difference on the pane can lead to breakage of the glass. Abrasives can scratch the pane, which on the one hand is undesirable for aesthetic and optical reasons, and in addition can lead to breakage of the glass and removal of the ceramic coating and thus the protection of the bond against UV.

So there is a need for compositions which efficiently, simply, and cost-effectively remove silicone contaminants.

### DESCRIPTION OF THE INVENTION

The aim of the present invention is to provide compositions for cleaning the surfaces of panes, in particular to remove silicone compounds, which overcomes the disadvantages of the prior art. It was surprisingly found that this aim is achieved by a use and a composition as specified in the independent claims.

The use of such compositions, including at least one carrier and at least one silicic acid and/or at least one silicate, leads to efficient removal of silicone compounds from a glass or glass ceramic surface, without damaging the glass or glass ceramic surface. Furthermore, such compositions have excellent processability.

Further advantageous embodiments of the invention follow from the subclaims.

### EMBODIMENT OF THE INVENTION

One aspect of the present invention relates to use of a composition including a carrier and silicic acid, preferably a pyrogenic silicic acid, and/or silicates for removal of undesirable contaminants, in particular silicone compounds or oils, which are found as contaminants on glass or glass ceramic surfaces.

A solvent or a material, in particular a fibrous material or a polymer matrix, can be used as a carrier in the composition according to the invention. If the carrier is a solvent, then the composition preferably is in the form of a suspension or a dispersion. The composition can have different viscosities, depending on the amount of solids added, in particular added silicic acid or silicates. The composition is preferably in the form of a liquid or a low-viscosity or high-viscosity paste.

Water and organic solvents are suitable as the solvent. The solvent should be selected based on technical and preferably also environmental considerations such as, for example, water hazard class or biodegradability.

Especially suitable as organic solvents are alcohols, preferably methanol, ethanol, propanol, isopropanol, butanol, higher alcohols such as ethylene glycol, glycerol, polyether polyols such as polyethylene glycol, and ether alcohols such as butyl glycol, methoxypropanol, and alkyl polyethylene glycols, but also aldehydes, esters, ethers, amides, or ketones, in particular acetone, methyl ethyl ketone, hydrocarbons, in particular methyl esters, ethyl esters, isopropyl esters, heptane, cyclohexane, xylene, toluene, mineral spirits (Stoddard solvent) as well as mixtures thereof. Ethyl acetate, ethanol, isopropanol, or heptane as well as mixtures thereof are regarded as preferred.

Water is preferred in particular as a solvent. Also preferred are mixtures of water with alcohols, with water content higher than 50 wt. %, preferably higher than 65 wt. %, in particular higher than 80 wt. %.

The solvent content is usually between 90 and 99.9 wt. %, in particular between 95 and 99.9 wt. %, preferably between 99 and 99.9 wt. %, relative to the weight of the composition. If the composition is a paste, the solvent content is between 85 and 99.9 wt. %, in particular between 88 and 98 wt. %, preferably between 90 and 96 wt. %, relative to the weight of the composition or the paste.

The solvent in the present invention is not for dissolving the silicic acid or the silicates, but rather is used as the carrier for these components. Other additives included by the composition according to the invention, however, can be dissolved in the solvent.

In one embodiment, the carrier is a fibrous material. In this entire document, a “fibrous material” is understood to mean a material composed of fibers. The fibers include or consist of organic or synthetic material. These can be in particular cellulose fibers, cotton fibers, protein fibers, or synthetic fibers. Especially preferred synthetic fibers include polyester fibers or fibers made from homopolymers or copolymers of ethylene and/or propylene or from viscose. Here the fibers can be short fibers or long fibers, spun, woven, or unwoven fibers or filaments. The fibers can additionally be oriented or drawn fibers. It is additionally advantageous that fibers be used together that are different with respect to geometry and composition.

The fiber material additionally includes holes. These holes are made by suitable manufacturing methods. Here it is preferable that the holes are not completely sealed off but rather that they be in contact with the surroundings directly or through channels. In this way, a spongy structure should be created that in particular enables a high capacity for absorbing liquids.

The objects assembled from fibers can be manufactured in many different ways known to the person skilled in the art. A woven, crossply, or knitted fabric can be used in particular as the object.

The fibrous material can be a loose material made from spun fibers or filaments, whose cohesion is provided generally by the adhesion of the fibers themselves. Here single fibers can have a preferred direction or be unoriented. The object made from fibers can be mechanically strengthened by needle punching or meshing, or by water-jet spinning.

Especially preferred as the fibrous material is a cloth, preferably a cloth made from cellulose or cotton fibers such as, for example, a paper cloth such as Tela®, commercially available from Tela-Kimberly Switzerland GmbH, or Kleenex®, commercially available from Hakle-Kimberly Schweiz. But a microfiber cloth, wool, felt, or fleece can also be used.

In order to manufacture a composition including a fibrous material as well as silicic acid and/or silicates, the fibrous material is preferably dipped in a suspension including silicic acid and/or silicates and a solvent, preferably an aqueous solvent. Solvents such as those already described above for the solvent used as the carrier are suitable as the solvent. Water or an organic solvent are especially suitable. The silicic acid and/or silicate content in the suspension is preferably between 0.01 and 10 wt. %, between 0.01 and 5 wt. %, preferably between 0.1 and 1 wt. %, in particular between 0.1 and 0.5 wt. %, especially preferably between 0.2 and 0.4 wt. %, relative to the total weight of the suspension.

The fibrous material can be used immediately or be dried after dipping in the suspension. The storage time for a dried fibrous material including silicic acid and/or silicates has no effect on the cleaning result. The suspension can additionally include a binder for improved adhesion of the silicic acid and/or silicates to the fibrous materials. Natural or synthetic substances can be used as a binder. If the fibrous material is dried, preferably either the fibrous material or the surface to be cleaned is wetted before use, preferably with water or a conventional cleaning agent, in particular with a glass cleaning agent. Wetting of the surface to be cleaned or the fibrous material with a composition including an adhesion promoter composition is especially preferred.

The advantage of using a composition including a fibrous material with silicic acid and/or silicates is that such a fibrous material with silicic acid and/or silicates can be sold and in application, any liquid can be used such as water, an organic solvent, or a conventional glass cleaner, which are applied in any way to the surface or the fibrous material, and thus can also be sprayed on.

In a further embodiment, the carrier is a polymer matrix. An especially suitable polymer matrix is one made from polymer which includes or consists of natural or synthetic elastic polymers, rubbers made from vulcanized natural rubber, or thermoplastics. A suitable polymer matrix is elastic at the temperature of use, i.e., at temperatures between −20° C. and 50° C., preferably between 0° C. and 40° C., especially preferably between 10° C. and 30° C., in particular at 20° C.

Examples of suitable polymers are cured products of polymers which have isocyanate groups, acrylate groups, epoxy groups, and/or silane groups or mixtures thereof, in particular polymers based on polyurethanes.

In a first embodiment, the polymer is a polyurethane-based polymer. Polyurethane-based polymers are synthesized from polyisocyanate, preferably from polyurethane prepolymers having several isocyanate groups

The polyurethane prepolymer is obtained by reaction of at least one polyisocyanate with a compound having two or more NCO-reactive functional groups. Such NCO-reactive groups are in particular hydroxyl, mercapto, and primary or secondary amino groups.

The compound having two or more NCO-reactive functional groups can be in particular polyols, polyamines, or polyamino alcohols.

Examples of polyamino alcohols are diethanolamine, ethanolamine, triethanolamine as well as the products of reaction between epoxides and amines, in particular reaction between diglycidyl ethers and polyamines.

Polyether polyols, polycarbonate diols, and polyester polyols are particularly preferred as the polyols.

Polyoxyalkylene diols or polyoxyalkylene triols, in particular polyoxypropylene diols or polyoxypropylene triols are especially suitable.

Particularly suitable polyester polyols are those which are synthesized, for example, from dihydric or trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols, reacted with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, as well as polyester polyols derived from lactones such as, for example, ε-caprolactone.

Especially preferred polyester polyols are polyester polyols derived from adipic acid, sebacic acid, or dodecanedicarboxylic acid as the dicarboxylic acid and from hexanediol or neopentyl glycol as the dihydric alcohol. The polyester polyols preferably have a molecular weight of 1500 to 15,0000 [sic, probably 15,000] g/mol, in particular 1500 to 8000 g/mol, preferably 2000 to 5500 g/mol.

Especially preferred polyester polyols are adipic acid/hexanediol polyester and dodecanedicarboxylic acid/hexanediol polyester.

The polyurethane prepolymers are synthesized by a method known in the prior art directly from polyisocyanates and NCO-reactive compounds, for example polyols, or by a stepwise adduct formation method.

Preferred polyurethane prepolymers are derived from polyols and polyisocyanates, in particular from diols, triols, or diol/triol mixtures as well as from diisocyanates, triisocyanates, or diisocyanate/triisocyanate mixtures.

An especially suitable carrier is a thermoplastic polymer matrix including or consisting of at least one thermoplastic which includes or consists of a copolymer made from at least two monomers. Preferred homopolymers or copolymers are made from unsaturated monomers, in particular selected from the group including ethylene, propylene, styrene, (meth)acrylic acid, ethylene terephthalate, amides, carbonates, ethylene sulfide, imide, and esters thereof, vinyl acetate, vinyl ester, and vinyl alcohol. Particularly suitable are ethylene vinyl acetate (EVA) as well as atactic poly-α-olefins (APAO), polypropylene (PP), polyethylene (PE), polyvinyl chloride (PVC), polystyrene (PS), acrylonitrile/butadiene/styrene copolymers (ABS), polycarbonate (PC), polyamide (PA), polyester (PE), polyoxymethylene (POM), particularly polyethylene (PE) or polypropylene (PP) or mixtures thereof. Especially preferred is a polymer matrix based on thermoplastic polyurethane.

Mixtures of two or more polymers (“polymer blends”) can also be used.

Besides the carrier, the composition according to the invention includes at least one silicic acid or at least one silicate or mixtures thereof. Those silicic acids or silicates are particularly preferred which have a Mohs hardness less than that of glass, preferably less than 7, preferably less than 6.6, particularly preferably less than 6, so that the glass or glass ceramic surface will not be scratched.

Examples of suitable silicic acids are amorphous or colloidal silicic acids such as pyrogenic silicic acids or silica gel. Especially preferred is a pyrogenic silicic acid, such as is commercially available as Aerosil® from Degussa.

The silicates include salts and esters of orthosilicic acid. Especially suitable silicates are sheet silicates, particularly sheet silicate clay minerals such as, for example, kaolinite, dickite, nacrite, smectite, glauconite, vermiculite, or bentonite. Bentonites are especially preferred.

If the carrier is a solvent, using a pyrogenic silicic acid as the silicic acid is preferred because of their very slow sedimentation behavior.

In a first embodiment, the silicic acid or silicate content in a composition including a solvent as the carrier is usually between 0.01 and 10 wt. %, between 0.01 and 5 wt. %, preferably between 0.1 and 1 wt. %, in particular between 0.1 and 0.5 wt. %, especially preferably between 0.2 and 0.4 wt. %, relative to the total weight of the composition.

In another especially preferred embodiment, the composition is in the form of a paste. In a paste including a solvent as the carrier, the solids content, preferably the silicic acid or silicate content, is usually between 0.01 and 15 wt. %, between 0.1 and 14 wt. %, preferably between 1 and 12 wt. %, in particular between 2 and 10 wt. %, especially preferably between 5 and 9 wt. %, relative to the total weight of the paste. The solids consist at least partially or completely of silicic acid or silicates, preferably Aerosil®. But in addition to silicic acid or silicates, the solid additives can contain other solids such as, for example, chalk.

The silicic acid or silicate content in a composition including a polymer matrix as the carrier is usually between 0.1 and 50 wt. %, in particular between 1 and 30 wt. %, preferably between 1 and 20 wt. %, especially preferably between 5 and 10 wt. %, relative to the total weight of the composition.

The silicic acid or silicates can, for example, be present in the carrier as a suspension or dispersion, or bound to the carrier.

In a further embodiment, the composition additionally includes a wetting agent. Compositions including a wetting agent are especially preferred if the carrier for the composition is a solvent, particularly water. As the wetting agent, natural or synthetic substances can be used which in solutions reduce the surface tension of water or other liquids. As the wetting agents (also called surfactants), anionic, cationic, nonionic, or ampholytic surfactants or mixtures thereof can be used.

Examples of anionic surfactants are surfactants having carboxylate, sulfate, phosphate, or sulfonate groups such as, for example, amino acid derivatives, alkylbenzenesulfonates, particularly dodecylbenzenesulfonates, fatty alcohol ether sulfates, fatty alcohol sulfates, soaps, alkylphenol ethoxylates, fatty alcohol ethoxylates, but also alkanesulfonates, olefin sulfonates, or alkyl phosphates.

Nonionic surfactants (“niosurfactants) include, for example, ethoxylates such as, for example, ethoxylated addition products of alcohols, amines, fatty acids, fatty acid amides, alkylphenols, ethanolamides, fatty amines, polysiloxanes or fatty acid esters, but also alkyl or alkylphenyl polyglycol ethers such as, for example, fatty alcohol polyglycol ethers, or fatty acid amides, alkyl glycosides, sugar esters, sorbitan esters, polysorbates, or trialkylamine oxides.

Examples of cationic surfactants are quaternary ammonium or phosphonium compounds such as, for example, tetraalkylammonium salts, N,N-dialkylimidazoline compounds, dimethyldistearylammonium compounds, or N-alkylpyridine compounds, particularly ammonium chlorides.

The ampholytic or amphoteric surfactants include amphoteric electrolytes (“ampholytes”) such as, for example, aminocarboxylic acids or betaines.

Polypropylene glycols, silicone-based surfactants, or fluorosurfactants can be used as the wetting agent.

Especially suitable wetting agents for the composition according to the invention are anionic surfactants, particularly alkylbenzenesulfonates, or nonionic surfactants, particularly ethoxylates. Especially suitable wetting agents are ethoxylated polysiloxanes, ethoxylated fluorosurfactants, dodecylbenzenesulfonates, or nonylphenol ethoxylates.

The wetting agent content is usually between 0 and 10 wt. %, particularly between 0 and 5 wt. %, preferably between 0.01 and 1 wt. %, especially preferably between 0.1 and 0.5 wt. %, relative to the total weight of the composition.

In another embodiment, the composition includes at least one adhesion promoter composition, in particular an adhesion promoter composition including at least one hydrolyzable adhesion promoter substance, containing or consisting of a silane and/or titanium compound.

The at least one hydrolyzable adhesion promoter substance can be an organosilicon compound. In principle, all organosilicon compounds known to the person skilled in the art are suitable which are used as adhesion promoters. Preferably this organosilicon compound has at least one, in particular at least two alkoxy groups, which is or are directly bonded to a silicon atom through an oxygen-silicon bond. In addition the organosilicon compound has at least one substituent, which is bonded to the silicon atom through a silicon-carbon bond, and which optionally has a functional group selected from the group including oxirane, hydroxy, (meth)acryloxy, amino, mercapto, and vinyl groups. The hydrolyzable adhesion promoter substance is in particular a compound of formula (I)

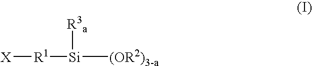

Here the substituent R¹ stands for a linear or branched, optionally cyclic alkylene group with 1 to 20 C atoms, optionally with aromatic moieties and optionally with one or more heteroatoms, in particular nitrogen atoms.

The substituent R² stands for an alkyl group with 1 to 5 C atoms, in particular a methyl or ethyl group.

Furthermore, here the substituent R³ stands for an alkyl group with 1 to 8 C atoms, in particular a methyl group, and the X stands for an H or a functional group selected from the group including oxirane, OH, (meth)acryloxy, amine, SH, and vinyl.

Finally, a stands for one of the values 0, 1, or 2. Preferably a=0.

The substituent R¹ is preferably a methylene, propylene, methylpropylene, butylene, or dimethylbutylene group. The substituent R¹ is preferably a propylene group.

Suitable organosilicon compounds are readily commercially available and are particularly preferably selected from among the group including methyltriacetoxysilane, ethyltriacetoxysilane, 3-methacryloxypropyltrialkoxysilanes, 3-aminopropyltrialkoxysilanes, bis[3-(trialkoxysilyl)propylamines, tris[3-(trialkoxysilyl)propyl]amines, 3-aminopropyltrialkoxysilanes, N-(2-aminoethyl)-(3-aminopropyl)trialkoxysilanes, N-(2-aminoethyl)-N-(2-aminoethyl)-(3-aminopropyl)trialkoxysilanes, 3-glycidyloxypropyltrialkoxysilanes, 3-mercaptopropyltrialkoxysilanes, vinyltrialkoxysilanes, methyltrialkoxysilanes, octyltrialkoxysilanes, dodecyltrialkoxysilanes, and hexadecyltrialkoxysilanes, where of the above-mentioned compounds, methoxysilane and ethoxysilane are particularly suitable.

The at least one hydrolyzable adhesion promoter substance can additionally be an organotitanium compound. In principle, all organotitanium compounds known to the person skilled in the art are suitable which are used as adhesion promoters.

Particularly suitable organotitanium compounds are those having at least one functional group which is selected from the group including an alkoxy group, a sulfonate group, phosphates, a carboxylate group, acetylacetonate, or mixtures thereof, and which is bonded directly to a titanium atom through an oxygen-titanium bond.

As the alkoxy groups, in particular isopropoxy and “neoalkoxy” substituents have proven to be especially suitable, in particular those of the following formula:

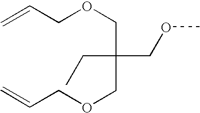

As the sulfonic acids, in particular aromatic sulfonic acids have proven to be especially suitable in which the aromatics are substituted with an alkyl group. Groups having the formula below are considered as preferred sulfonic acids:

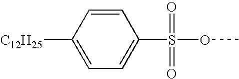

As the carboxylate groups, fatty acid carboxylates in particular have proven to be especially suitable. Stearates and isostearates are considered as preferred carboxylates.

Here in all the above formulas, the dashed bond indicates the bond to the titanium atom.

Organotitanium compounds are commercially available, for example from Kenrich Petrochemicals or DuPont. Examples of suitable organotitanium compounds are, for example, Ken-React® KR TTS, KR 7, KR 9S, KR 12, KR 26S, KR 33DS, KR 38S, KR 39DS, KR44, KR 134S KR 138S, KR 158FS, KR212, KR 238S, KR 262ES, KR 138D, KR 158D, KR238T, KR 238M, KR238A, KR238J, KR262A, LICA 38J, KR 55, LICAI, LICA 09, LICA 12, LICA 38, LICA 44, LICA 97, LICA 99, KR OPPR, KROPP2, from Kenrich Petrochemicals or Tyzor® ET, TPT, NPT, BTM AA, AA-75, AA-95, AA-105, TE, ETAM from DuPont. Ken-React® KR 7, KR 9S, KR 12, KR 26S, KR 38S, KR44, LICA 09, LICA 44 as well as Tyzor® ET, TPT, NPT, BTM, AA, AA-75, AA-95, AA-105, TE, ET AM from DuPont are considered as preferred.

The at least one hydrolyzable adhesion promoter substance can additionally be an organozirconium compound. In principle, all organozirconium compounds known to the person skilled in the art are suitable which are used as adhesion promoters. Particularly suitable organozirconium compounds are those which have at least one functional group, selected from the group including alkoxy groups, sulfonate groups, carboxylate groups, phosphate, or mixtures thereof, and which is bonded directly to a zirconium atom through an oxygen-zirconium bond.

As the alkoxy groups, in particular isopropoxy and “neoalkoxy” substituents have proven to be especially suitable, in particular those of the following formula:

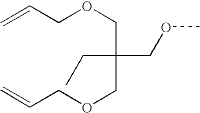

As the sulfonic acids, in particular aromatic sulfonic acids have proven to be especially suitable in which the aromatics are substituted with an alkyl group. Groups having the formula below are considered as preferred sulfonic acids:

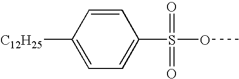

As the carboxylate groups, fatty acid carboxylates in particular have proven to be especially suitable. Stearates and isostearates are considered as preferred carboxylates.

Here in all the above formulas, the dashed bond indicates the bond to the zirconium atom.

Organozirconium compounds are commercially available, for example from Kenrich Petrochemicals. Examples of suitable organozirconium compounds are, for example, Ken-React® NZ 38J, NZ TPPJ, KZ OPPR, KZ TPP, NZ 01, NZ 09, NZ 12, NZ38, NZ 44, NZ 97.

Furthermore, the adhesion promoter substance of the composition according to the invention can contain mixtures of at least one organosilicon compound with at least one organotitanium compound and/or with at least one organozirconium compound. Mixtures of at least one organotitanium compound with at least one organozirconium compound are also possible. Mixtures of at least one organosilicon compound with at least one organotitanium compound are preferred.

Mixtures of several organosilicon compounds or mixtures of an organosilicon compound with an organotitanium compound or an organozirconium compound are especially preferred.

Especially good mixtures of organosilicon compounds have proven to be mixtures of adhesion promoter substances of formula (I), where at least one of these substituents [sic, “substituents” should be “substances”] has H as substituent X and at least one of these substances has a functional group selected from among the group including oxirane, (meth)acryloxy, amine, SH, and vinyl as substituent X. These mixtures preferably include at least one alkyltrialkoxysilane with an aminoalkyltrialkoxysilane and/or mercaptoalkyltrialkoxysilane.

The adhesion promoter composition can include other constituents besides the described hydrolyzable adhesion promoter substances. For the case when the carrier of the composition according to the invention is not an organic solvent, such adhesion promoter compositions preferably include, besides the hydrolyzable adhesion promoter substance, at least one organic solvent. Organic solvents such as described above for the carrier are particularly suitable.

As another component in the adhesion promoter composition, a reactive binder can be present, where in particular polyurethane prepolymers with isocyanate groups and/or silane groups should be mentioned; or polyisocyanates can be present, for example tris(4-isocyanatophenyl)methane, tris(4-isocyanatophenyl)thiophosphate, the already mentioned monomers MDI, TDI, HDI, and IPDI, as well as oligomers, polymers, or copolymers of these monomers, such as HDI polymers, MDI polymers such as, for example, those commercially available as Voranate® M 229 (Dow), Desmodur® VL R 20 (Bayer), or allophanates, biurets, uretdiones and isocyanurates of these monomers, in particular HDI biurets such as, for example, those commercially available as Desmodur® N-100 (Bayer), Luxate® HDB 9000 (Lyondell/Bayer), HDI trimers such as, for example, those commercially available as Desmodur® N-3300 (Bayer), Desmodur® N-3600 (Bayer), Luxate® HT 2000 (Lyondell/Bayer), Desmodur® XP 2410, HDI dimers such as, for example, those commercially available as Desmodur® N-3400 (Bayer), Luxate® HD 100 (Lyondell/Bayer), IPDI trimers such as, for example, those commercially available as Desmodur® Z 4470 (Bayer), Vestanat® T 1890 (Degussa), Luxate® IT 1070 (Lyondell/Bayer), HDI and IPDI allophanates, TDI trimers such as, for example, those commercially available as Desmodur® IL (Bayer), TDI adducts such as, for example, those commercially available as Desmodur® L (Bayer), TDI/HDI polymers such as, for example, those commercially available as Desmodur® HL (Bayer), Polurene® 1K D (Sapici), Hartben AM 29 (Benasedo).

Hydrolysis catalysts, for example for hydrolysis of silane groups, can also be used as a constituent of the adhesion promoter composition, and namely for example in the form of organic carboxylic acids such as benzoic acid or salicylic acid, organic carboxylic acid anhydrides such as phthalic anhydride or hexahydrophthalic anhydride, silyl esters of organic carboxylic acids, organic sulfonic acids such as p-toluenesulfonic acid or 4-dodecylbenzenesulfonic acid, or other organic or inorganic acids, or mixtures of the aforementioned acids; as well as catalysts for reaction of isocyanate groups, for example, tin compounds such as tin(II) octoate, monobutyltin trichloride, dibutyltin dichloride, dibutyltin oxide, dibutyltin diacetate, dibutyltin dilaurate, dibutyltin diacetylacetonate, dibutyltin dicarboxylates, dioctyltin dicarboxylates, alkyltin thioesters, bismuth compounds such as bismuth(III) octoate, bismuth(III) neodecanoate, zinc compounds such as zinc(II) octoate, as well as compounds containing amino groups such as, for example, 2,2′-dimorpholinodiethyl ether, 1,4-diazabicyclo[2.2.2]octane, 1,8-diazabicyclo[5.4.0]undec-7-ene; as well as other catalysts such as titanates and zirconates.

Furthermore, the usual wetting agents, fillers, and additives employed in primer chemistry can be used. Non-limiting examples for this purpose are talc, carbon black, organic and inorganic pigments, stabilizers, as well as chemical and physical drying agents.

The described adhesion promoter composition is prepared and stored away from moisture.

A composition according to the invention including an adhesion promoter composition is especially advantageous when the carrier is an organic solvent. The composition containing an adhesion promoter has the advantage that one application step can be omitted, because the cleaned surface to which an adhesive is to be applied no longer has to be pretreated with an adhesion promoter before application of the adhesive, since pretreatment with the adhesion promoter already occurs while cleaning with the composition according to the invention that includes an adhesion promoter composition. If an adhesive is used that also adheres well to the surface without an adhesion promoter, no adhesion promoter is necessary either in the composition according to the invention or as pretreatment of the cleaned surface.

As needed, the composition can additionally contain the usual additives, in particular flow-control agents, defoamers, surfactants, biocides, antisettling agents, stabilizers, inhibitors, pigments, fillers such as, for example, chalk, dyes, or scents.

In an especially preferred embodiment, for use as a cleaning agent to remove undesirable contaminants, the composition includes water, pyrogenic silicic acid, as well as a wetting agent, or it includes an organic solvent, pyrogenic silicic acid, and a silane-containing adhesion promoter. The composition preferably consists of water, pyrogenic silicic acid, as well as a wetting agent, or else an organic solvent, pyrogenic silicic acid, and a silane-containing adhesion promoter. In another preferred embodiment, the composition includes or preferably the composition consists of a polyurethane-based polymer matrix and pyrogenic silicic acid.

In another preferred embodiment, the composition includes or preferably the composition consists of a fibrous material and pyrogenic silicic acid. This composition is wetted for cleaning a surface, preferably with a solution including an adhesion promoter composition.

The composition described above is preferably used to remove undesirable contaminants, in particular silicone compounds or oils, which are found as contaminants on the surface of a pane, in particular on a glass or glass ceramic surface. Non-limiting examples of such contamination include lamination processes, where silicone-containing seals are used on a glass or glass ceramic surface; release agents and lubricants based on mineral oils or silicone-like contaminants; manufacturing processes, for example “pressbending”, and dust deposited over time or during transport; fingerprints or hand creams.

In the entire description in this text, “pane” is understood to mean a flat or curved plate of glass or essentially transparent plastic. Here the plates can be single-layer or multilayer, in particular they also can be panes with films between the glass plates, as they are used as safety glass panes in automobile assembly, for example for the windshield, and/or they can be panes with a ceramic coating, preferably glass panes with a ceramic coating.

In another aspect, the present invention relates to use of a pyrogenic silicic acid as a cleaning agent, in particular as a cleaning agent to remove oil, grease, or silicone. Especially preferred is the use of a pyrogenic silicic acid to remove silicone compounds from a glass or glass ceramic surface.

Another aspect of the present invention relates to a method for cleaning a surface of a substrate S1, preferably a glass or glass ceramic surface, characterized in that the surface of substrate S1 is cleaned with a composition according to the invention.

In another aspect, the present invention relates to a method for bonding substrates S1 and S2 including the steps (a) cleaning the surface of substrate S1 with a composition according to the invention; (b) applying an adhesive to the surface of substrate S1 or S2; (c) bringing the surface of substrate S2 into contact with the adhesive which is placed on substrate S1, or bringing the surface of substrate S1 into contact with the adhesive which is placed on substrate S2; and (d) curing the adhesive.

Substrates S1 and S2 are the same or different from each other. Preferably substrate S1 is a pane, preferably a glass pane, preferably with a ceramic coating. Substrate S2 can represent a large number of materials. Particularly suitable substrates are plastics, organic materials such as leather, cloth, paper, wood, resin-bonded wood products, resin/textile composites, glass, porcelain, ceramic, as well as metals, in particular lacquered metal.

Suitable plastics are in particular polyvinyl chloride (PVC), acrylonitrile/butadiene/styrene copolymer (ABS), SMC (sheet molding compound), polycarbonate (PC), polyamide (PA), polyester (PE), polyoxymethylene (POM), polyolefins, in particular polyethylene (PE) or polypropylene (PP), preferably with plasma, corona, or flame surface-treated PP or PE. Therefore the method according to the invention can be preferably used in automotive assembly, where glass is bonded to a lacquer-coated auto body, or in door or window assembly, where glass is bonded to a wooden or plastic frame.

In this entire application, “cleaning” or “to clean” are understood to mean cleaning a surface, preferably a glass or glass ceramic surface, i.e., removal of undesirable material from a surface, preferably removal of silicone compounds. For cleaning, the composition according to the invention is rubbed over a surface to be cleaned once or more times, preferably 2 to 40 times, even more preferably 4 to 30 times, ever more preferably 10 to 20 times, especially preferably 20 times. Rubbing once means that the composition according to the invention, in contact with the surface to be cleaned, is moved once in one direction without lifting from the surface and without interruption. If rubbed several times, the rubbing can be in the same direction or in different directions. Rubbing is preferably done alternately in opposite directions. The rubbing can be done manually or mechanically, in particular by means of a robot. Preferably light pressure should be exerted on the surface to be cleaned while rubbing. Preferably rubbing should be continued long enough so that the surface to be cleaned is essentially completely wetted if rubbed with a cloth that has been wetted with an aqueous solution.

For the case when the composition according to the invention includes a solvent as carrier, the composition is applied preferably to a fibrous material or sponge and then is rubbed over the surface to be cleaned with the moistened fibrous material or sponge. If the composition is a paste, preferably the fibrous material or sponge or the surface to be cleaned is wetted, preferably with a liquid, in particular with water or a conventional pane cleaner, and then the paste is applied to the fibrous material or sponge or the wetted surface and then is rubbed over the surface to be cleaned with the fibrous material or sponge.

If the composition according to the invention includes a material, preferably a polymer matrix or a fibrous material, as the carrier, the composition is preferably directly rubbed over the surface to be cleaned. If the carrier is a fibrous material, preferably the fibrous material or the surface to be cleaned is wetted for cleaning, preferably with a liquid, in particular water or a solution including an adhesion promoter substance.

To test whether the undesirable contamination on the surface has been removed, the surface can be wetted with an aqueous solution. If the surface is well wetted, then at the wetted spot the surface is essentially free of oils, greases, or silicone-containing contaminants. An adhesion test can also be carried out with an adhesive bonded to the cleaned surface, as described in the Examples as the “bead test”.

An adhesive is used at some time after substrate S1 is cleaned with the composition according to the invention. Here in a first embodiment, the adhesive is applied to the cleaned substrate S1 and then brought into contact with substrate S2. In a second embodiment, the adhesive is applied to substrate S2 and then brought into contact with the cleaned substrate S1.

It has been shown that polyurethane adhesives, (meth)acrylate adhesives, epoxy resin adhesives, or adhesives based on prepolymers with alkoxysilane functional groups are best suited for bonding.

Suitable polyurethane adhesives are firstly one-component moisture-curing adhesives or two-component polyurethane adhesives. Such adhesives contain polyisocyanates, in particular in the form of prepolymers containing isocyanate groups. Preferred polyurethane adhesives are those such as are commercially available from Sika Schweiz AG in the Sikaflex®, SikaPower®, and SikaForce® product lines.

(Meth)acrylate adhesives are understood to mean two-component adhesives for which the first component includes acrylic acid and/or methacrylic acid and/or their esters, and the second component includes a radical former, in particular a peroxide. Adhesives such as are commercially available in the SikaFast® product line from Sika Schweiz AG are preferred.

Epoxy resin adhesives are understood to mean adhesives which are formulated on the basis of glycidyl ethers, in particular diglycidyl ethers of bisphenol A and/or bisphenol F. Especially suitable are two-component epoxy resin adhesives for which one component contains diglycidyl ethers of bisphenol A and/or bisphenol F and the second component contains polyamines and/or polymercaptans. Preferred two-component epoxy resin adhesives are those such as commercially available in the Sikadur® product line from Sika Schweiz AG. The two-component epoxy resin adhesives Sikadur®-Combiflex®, Sikadurg-31, Sikadur®-31 DW, and Sikadur®-33, preferably Sikadur®-Combiflex®, from Sika Schweiz AG have been shown to be especially suitable for bonding films.

Adhesives based on prepolymers containing alkoxysilane functional groups are understood to mean in particular adhesives based on MS polymers or SPUR (silane-terminated polyurethane) prepolymers. Such alkoxysilane-functional prepolymers can be synthesized, for example, via a hydrosilylation reaction between polyethers having at least two C═C double bonds, in particular allyl-terminated polyoxyalkylene polymers, and a hydrosilane, or via an addition reaction between isocyanatoalkylalkoxysilanes and polyols or hydroxy-functional polyurethane prepolymers, or via an addition reaction between aminoalkylalkoxysilanes and isocyanate-functional polyurethane prepolymers, where the polyurethane prepolymers themselves can be obtained via reaction of polyisocyanates and polyols and/or polyamines by a method known in the prior art. Adhesives based on alkoxysilane-functional prepolymers are moisture-curing and react at room temperature.

In principle, reactive hot melt adhesives can also be used, such as are commercially available from Sika Schweiz AG in the SikaMelt® product line. However, room temperature-curing adhesives are preferred.

In another embodiment, the bonding method includes another step (a′) between step (a) and step (b). This step (a′) includes application of an adhesion promoter composition to the surface of substrate S1. This embodiment is advantageous if the composition according to the invention for cleaning the surface of substrate S1 does not include an adhesion promoter composition. As the adhesion promoter compositions, the same adhesion promoter compositions as described above for the composition according to the invention can be used. The adhesion promoter composition is applied to the substrate using a brush, felt, cloth, or sponge. This application can be done manually or mechanically, in particular by means of a robot. Furthermore, several coats of the adhesion promoter composition can be applied.

It can also be advantageous for the surface of substrate S2 to be pretreated before bonding. This can involve application of an adhesion promoter composition and/or mechanical cleaning.

After the adhesive is brought into contact with substrate S2, the adhesive is cured. However, of course the person skilled in the art is aware that crosslinking of the adhesive begins right after mixing for two-component adhesives, or immediately after contact with moisture in the air for one-component polyurethane adhesives or adhesives based on alkoxysilane-functional prepolymers. Thus the term “curing” in step (d) is to be understood as not the beginning of curing, i.e., the beginning crosslinking, but rather means that the crosslinking has already progressed far enough that the adhesive already has developed strength high enough so that it can carry loads, and the “early strength” has been achieved. The curing is complete when the adhesive has reached its final strength.

In another aspect, the present invention relates to a composition including at least one fibrous material and at least one silicic acid, preferably a pyrogenic silicic acid, and/or at least one silicate. Suitable fibrous materials are such materials as already described above for the carrier, in particular a cellulose, cotton, or microfiber cloth.

Those silicic acids or silicates are particularly preferred which have a Mohs hardness less than that of glass, preferably less than 7, preferably less than 6.6, particularly preferably less than 6, so that the glass or glass ceramic surface will not be scratched.

Examples of suitable silicic acids are amorphous or colloidal silicic acids such as pyrogenic silicic acids or silica gel. A pyrogenic silicic acid is especially preferred, commercially available, for example, as Aerosil® from Degussa.

The silicates include salts and esters of orthosilicic acid. Especially suitable silicates are sheet silicates, particularly sheet silicate clay minerals such as, for example, kaolinite, dickite, nacrite, smectite, glauconite, vermiculite, or bentonite. Bentonites are especially preferred.

The present invention further relates to a composition which does not include an organic polymer or prepolymer and which does include at least one solvent and at least one silicic acid and/or at least one silicate.

As the silicic acid or silicates, those silicic acids or silicates are preferred as described above for the composition including a fibrous material and at least one silicic acid and/or at least one silicate. A pyrogenic silicic acid is especially preferred.

Suitable solvents are such solvents as described above for the carrier, in particular water or an organic solvent. An organic solvent is especially preferred.

In another aspect, the present invention relates to a composition consisting of

(a) at least one solvent A in an amount w=100 wt. %−(x+y+z);

(b) at least one hydrolyzable adhesion promoter substance B, selected from among the group consisting of at least one silane compound and/or at least one titanate compound in an amount x, where x is the total weight of all the adhesion promoter substances B and x has a value from 0 to 10 wt. %, preferably 0.1 to 5 wt. %, especially preferably 1 to 3 wt. %;

(c) at least one substance C, selected from among the group consisting of at least one silicic acid, preferably a pyrogenic silicic acid, and/or at least one silicate, in an amount y, where y is the total weight of all substances C and y has a value from 0.001 to 15 wt. %, preferably from 0.01 to 14 wt. %, especially preferably from 0.1 to 10 wt. %, particularly preferably from 1 to 9 wt. %; and

(d) optionally at least one additive D in an amount z, where z is the total weight of all additives D and z has a value from 0 to 5 wt. %, preferably from 0 to 1 wt. %, especially preferably from 0.1 to 0.5 wt. %, particularly preferably from 0.1 to 0.2 wt. %;

assuming that x=0 when the solvent is water.

If the composition is a liquid, the amount y of substance C preferably has a value from 0.001 to 10 wt. %, preferably 0.01 to 5 wt. %, especially preferably from 0.1 to 3 wt. %, particularly preferably from 1 to 2 wt. %.

If the composition is a paste, the amount y of substance C preferably has a value from 0.001 to 15 wt. %, preferably 0.01 to 14 wt. %, especially preferably from 2 to 10 wt. %, particularly preferably from 5 to 9 wt. %.

The weight percents w, x, y, and z are respectively relative to the total weight of the composition consisting of A, B, C, and optionally D. This composition consisting of A, B, C and optionally D in particular does not contain any organic polymer or prepolymer. It is obvious to the person skilled in the art that the at least one adhesion promoter substance B in the composition consisting of A, B, C, and optionally D in a negligible amount can be present in hydrolyzed or oligomerized form.

Suitable as solvent A are such solvents as described above for the carrier, in particular water or an organic solvent. An organic solvent is especially preferred. If solvent A is an organic solvent, then the adhesion promoter substance B is preferably present in an amount x>0. As the hydrolyzable adhesion promoter substances B, such adhesion promoter substances can be used as described above for the adhesion promoter compositions. As substance C, selected from among the group including silicic acid or silicates, those silicic acids or silicates are preferred as are described above for the composition including a fibrous material and at least one silicic acid and/or at least one silicate. Pyrogenic silicic acid or silica gel are especially preferred. Conventional additives can be used as additive D, in particular flow-control agents, defoamers, surfactants, biocides, antisettling agents, stabilizers, inhibitors, pigments, fillers such as, for example, chalk, dyes, or scents.

It has surprisingly been shown that the composition according to the invention described above are excellently suitable for removing silicone compounds from surfaces of panes. Furthermore, it has been shown that the surface of a substrate, particularly a glass or glass ceramic surface, treated and in particular cleaned with a composition according to the invention as described above, has greatly improved bondability. This is also possible without needing additional pretreatments such as application of adhesion promoter compositions.

### EXAMPLES

The invention will now be explained in more detail with the help of Examples. These shall illustrate the invention further but do not limit the scope of the invention in any way.

TABLE 1
Raw materials used
Raw materials used

| Trade name | Supplier | Type | Abbreviated name |
|---|---|---|---|
| Bentone ® | Rheox Inc., | | Bentone |
| | Hightstown NJ USA | | |
| Silica gel | Fluka, Switzerland | Silica Gel 60 for flash | |
| | | chromatography | |
| Aerosil ® 90, Aerosil ® | Degussa AG, | Pyrogenic silicic acid | Aerosil 90, Aerosil |
| 200, Aerosil R 972 V | Switzerland | | 200, Aerosil 972 |
| Rhodoclean ® EFC, | Rhodia, Inc. USA | EO/PO terpene | EFC, MSC |
| Rhodoclean ® MSC | | | |
| Zonyl ® FSO-100 | DuPont, Switzerland | Ethoxylated | Zonyl |
| | | fluorosurfactant | |
| Sodium | Fluka, Switzerland | | Na-DBS |
| dodecylbenzenesulfonate | | | |
| Tergitol ® TMN-6 | Dow Chemical | Branched secondary | Tergitol |
| | Company, | alcohol ethoxylate | |
| | Switzerland | | |
| BYK ®-333 | Byk Chemie GmbH, | Polyether-modified | BYK-333 |
| | Wesel, Germany | dimethylpolysiloxane | |
| Sika ® CleanGlass | Sika Schweiz AG, | Alcohol-based glass | |
| | Switzerland | cleaner | |
| Silquest ® A-1110 Silane | GE Silicones, | Aminopropyltrimethoxy- | A-1110 |
| | Germany | silane | |
| Aminopropyltrimethoxysilane | A1110 | | |
| Sika ® Aktivator | Sika Schweiz AG, | | |
| | Switzerland | | |
| Dibutyltin dilaurate | Fluka, Switzerland | | DBTL |
| Scotch-Brite ™ High | 3M ™ | Polyester, nylon | Microfiber cloth |
| Performance Cloth | | | |

1. Composition with Solvent as Carrier

Wetting agents or adhesion promoter substances were added to the solvents and then the silicic acid or silicate solids were added to the mixture. The amounts of added materials are given in Table 2. A total of 20 g of each composition was prepared. A lint-free cellulose cloth was soaked with the prepared composition. When a paste was used as the composition (see Table 3), a lint-free cellulose cloth was soaked with a conventional pane cleaner, for example, Sika® CleanGlass, and then the paste was applied to the cellulose cloth soaked with the pane cleaner. Then the soaked cellulose cloth was rubbed 4 or 20 times over spots on a substrate contaminated by silicone compounds. Then the substrate was rubbed again with a dry lint-free cloth. All the cleaning and adhesive application experiments were carried out at 23° C. and 50% relative air humidity. The windshield of an Opel Corsa with visible silicone contamination on the glass ceramic edge was used as the substrate. The windshield was from the model Opel Corsa 1855C Saint-Gobain SEKURIT DOT 215 mL61 SA1 43R-0030005.

If the composition did not contain any adhesion promoter substance A111, then the glass surface was activated after treatment with the composition according to the invention using Sika® Aktivator (commercially available from Sika Schweiz AG).

After treatment of the surface with the composition according to the invention and optionally activation by Sika® Aktivator, an adhesive was applied to the cleaned glass ceramic surface. Triangular beads of the one-component, moisture-curing polyurethane adhesive SIKATACK®-MOVE GOES COOL (commercially available from Sika Schweiz AG) were applied in each case, using an extrusion cartridge and nozzle. The triangular beads were pressed down using polyethylene film (commercially available from Prodinger Verpackung AG, Switzerland).

The adhesive was tested after a cure time of 7 days storage in an environmental chamber (EC) (23° C., 50% relative air humidity).

The adhesion of the adhesive was tested using the “bead test”. For this, the bead is cut at the end just above the bonding surface. The cut end of the bead is held with round-tip forceps and pulled from the substrate. This is done by carefully rolling up the bead on the tip of the forceps, and placing a cut perpendicular to the direction in which the bead is pulled, down to the bare substrate. The bead peel rate should be selected so that a cut must be made approximately every 3 seconds. The test distance must be at least 8 cm. The adhesive remaining on the substrate after peeling off the bead is assessed (cohesive failure). The adhesive properties are assessed by estimating the area fraction of cohesive failure on the bonding surface:

=>95% cohesive failure

=75%-95% cohesive failure

=25%-75% cohesive failure

=<25% cohesive failure

=0% cohesive failure (purely adhesive failure)

Test results with cohesive failures below 75% are typically regarded as unsatisfactory.

The adhesion results from Tables 2 and 3 show that adhesion of the adhesive to the glass ceramic surface cleaned before application of the adhesive with a composition including Aerosil®, silica gel, or Bentone® was considerably improved. Table 4 shows that the reference compositions Ref 1, Ref 2, Ref 3, and Ref 4 cannot completely remove silicone contaminants from the glass ceramic surfaces, and the adhesive therefore does not adhere or does not adhere well to surfaces contaminated by silicone compounds.

TABLE 2
Compositions (20 g total) including solvent and adhesion of adhesive
to a glass ceramic surface cleaned with this composition.

| | | | | | | | | Result of bead | |
|---|---|---|---|---|---|---|---|---|---|
| | | | | | | | | test for rubbing | |
| | | | Wetting | | Adhesion | Solid | | x times | |
| No. | Solvent | | agent | | promoter | additive | | x = 4 | x = 20 |
| 1 | 19.84 | g H₂O | 0.08 | g MSC | | 0.08 | g Aerosil 200 | 4 | 1 |
| 2 | 19.84 | g H₂O | 0.08 | g MSC | | 0.08 | g Aerosil 90 | 4 | 1 |
| 3 | 19.84 | g H₂O | 0.08 | g MSC | | 0.08 | g silica gel | 4 | 2 |
| 4 | 19.84 | g H₂O | 0.08 | g MSC | | 0.08 | g Bentone | 4 | 3 |
| 5 | 19.9 | g H₂O | 0.08 | g MSC | | 0.02 | g Aerosil 200 | 4 | 3 |
| 6 | 19.72 | g H₂O | 0.08 | g MSC | | 0.2 | g Aerosil 200 | 2 | 1 |
| 7 | 19.84 | g H₂O | 0.08 | g EFC | | 0.08 | g Aerosil 200 | 3 | 1 |
| 8 | 19.84 | g H₂O | 0.08 | g BYK-333 | | 0.08 | g Aerosil 200 | 4 | 1 |
| 9 | 19.84 | g H₂O | 0.08 | g Zonyl | | 0.08 | g Aerosil 200 | 4 | 2 |
| 10 | 19.84 | g H₂O | 0.08 | g Na-DBS | | 0.08 | g Aerosil 200 | 4 | 1 |
| 11 | 19.84 | g H₂O | 0.08 | g Tergitol | | 0.08 | g Aerosil 200 | 3 | 1 |
| 12 | 19.9 | g H₂O | 0.02 | g MSC | | 0.08 | g Aerosil 200 | 1 | 1 |
| 13 | 19.88 | g H₂O | 0.04 | g MSC | | 0.08 | g Aerosil 200 | 4 | 1 |
| 14 | 19.72 | g H₂O | 0.2 | g MSC | | 0.08 | g Aerosil 200 | 4 | 1 |
| 15 | 19.9 | g H₂O | 0.02 | g BYK-333 | | 0.08 | g Aerosil 200 | 1 | 1 |
| 16 | 19.88 | g H₂O | 0.04 | g BYK-333 | | 0.08 | g Aerosil 200 | 4 | 1 |
| 17 | 19.72 | g H₂O | 0.2 | g BYK-333 | | 0.08 | g Aerosil 200 | 4 | 1 |
| 18 | 19.84 | g heptane | 0.08 | g MSC | | 0.08 | g Aerosil 200 | 3 | 1 |
| 19 | 17.98 | g heptane | | | 2 g A1110 | 0.02 | g Aerosil 200 | 5 | 1 |

TABLE 3
Paste (20 g total) including solvent and adhesion of adhesive to a cleaned glass
ceramic surface which was rubbed with this paste applied to a moistened cloth.

| | | | | | Result of bead | |
|---|---|---|---|---|---|---|
| | | | | | test for rubbing | |
| | | Wetting | Adhesion | Solid | x times | |
| No. | Solvent | agent | promoter | additive | x = 4 | x = 20 |
| 19A | 18.25 g H₂O | 0.05 g MSC | | 1.7 g Aerosil 200 | 2 | 1 |

TABLE 4
Reference compositions (20 g total) and adhesion of adhesive
to a glass ceramic surface cleaned with this composition.

Result of bead test
for rubbing x times

| No. | Composition | x = 4 | x = 20 |
|---|---|---|---|
| Ref 1 | 20 g Sika CleanGlass | | 1 |
| Ref 2 | 18 g heptane + 2 g A1110 | 5 | 5 |
| Ref 3 | 20 g Sika Aktivator | 5 | 5 |
| 4 | 20 g H₂O on microfiber cloth | 5 | 4 |

2. Composition with Fibrous Material as Carrier

A cellulose cloth was dipped in a suspension of Aerosil® and heptane and then dried at room temperature for 1 h. The dried cloth was wetted with an adhesion promoter solution, and then the wetted cloth was rubbed 4 or 20 times over the spots on a substrate contaminated by silicone compounds. Then the substrate was rubbed again with a dry lint-free cloth. All the cleaning and adhesive application experiments were carried out at 23° C. and 50% relative air humidity. The windshield of an Opel Corsa with visible silicone contamination on the glass ceramic edge was used as the substrate. The windshield was from the model Opel Corsa 1855C Saint-Gobain SEKURIT DOT 215 ML61 SA1 43R-0030005. After treatment, the glass surface was activated with Sika® Aktivator (commercially available from Sika Schweiz AG) and triangular beads of the one-component, moisture-curing polyurethane adhesive SIKATACK®-MOVE GOES COOL (commercially available from Sika Schweiz AG) were applied to the cleaned glass ceramic surface using an extrusion cartridge and nozzle. The triangular beads were pressed down using polyethylene film (commercially available from Prodinger Verpackung AG, Switzerland).

The adhesive was tested after a cure time of 7 days storage in an environmental chamber (EC) (23° C., 50% relative air humidity). The adhesion of the adhesive was tested using the “bead test” as described above.

TABLE 5
Adhesion of the adhesive to a glass surface which was cleaned with a
cellulose cloth that was first dipped in a suspension including Aerosil ®,
dried, and then dipped in an adhesion promoter solution, and at the
same time was activated by the cleaning in one step.

| | | | Result of bead test | |
|---|---|---|---|---|
| | | Adhesion promoter | for rubbing x times | |
| No. | Suspension | solution | 4x | 20x |
| 20 | 19.8 g heptane + | 18 g heptane + | 1 | 1 |
| | 0.2 g Aerosil 200 | 2 g A1110 | | |

Table 5 shows that a cellulose cloth coated with Aerosil® can efficiently remove silicone contaminants from a glass surface and thus there is good adhesion.

3. Composition with a Polymer Matrix as Carrier

Different solid additives, such as silicic acid or silicates, were stirred into the polyurethane prepolymer PP1 or PP2. The composition including PP1 was allowed to cure for 7 days stored in an environmental chamber (EC) (23° C., 50% relative air humidity). The composition including PP2 was allowed to cure for 7 days stored in an environmental chamber (EC) (50° C., 50% relative air humidity).

The polyurethane prepolymer PP1 was prepared as follows: 885 g Polyol Acclaim® 4200 N (Bayer; polypropylene oxide diol, OH value 28.5 mg KOH/g) and 115 g 4,4′-methylene diphenyl diisocyanate (MDI; Desmodurs 44 MC L, Bayer) were reacted at 80° C. to form an NCO-terminated polyurethane polymer according to a method known in the prior art. The reaction product had a titrimetrically determined free isocyanate group content of 1.86 wt. % and a viscosity at 20° C. of 37 Pa·s.

The polyurethane prepolymer PP2 was prepared as follows:

Under a nitrogen atmosphere, 1000 g Polyol Acclaim® 12200 (Bayer; low monol polyoxypropylene diol, OH value 11.0 mg KOH/g, water content about 0.02 wt. %), 43.6 g isophorone diisocyanate (IPDI; Vestanat® IPDI, Degussa), 126.4 g diisodecylphthalate (DIDP; Palatinol® Z, BASF), and 0.12 g di-n-butyltin dilaurate were heated to 90° C. with continuous stirring, and kept at this temperature until the titrimetrically determined free isocyanate group content reached a value of 0.63 wt. %. Then 62.3 g of N-(3-trimethoxysilyl)propyl aminosuccinic acid diethyl ester was mixed in, and the mixture was stirred for 4 hours at 90° C. until free isocyanate could no longer be detected by IR spectroscopy. The product was cooled down to room temperature and stored away from moisture (theoretical polymer content=89.7%).

N-(3-Trimethoxysilyl)propyl aminosuccinic acid diethyl ester was prepared as follows: 51.0 g 3-aminopropyltrimethoxysilane (Silquest® A-1110, GE Advanced Materials) were added. 49.0 g maleic acid diethyl ester were added slowly at room temperature with good stirring, and the mixture was stirred for 8 hours at room temperature.

The amounts of added materials are given in Table 6. A total of 50 g of each composition was prepared. Then the cured polymer matrix was rubbed 20 times over the spots on a substrate contaminated by silicone compounds. Then the substrate was rubbed again with a dry lint-free cloth. All the cleaning and adhesive application experiments were carried out at 23° C. and 50% relative air humidity. The windshield of an Opel Corsa with visible silicone contamination on the glass ceramic edge was used as the substrate. The windshield was from the model Opel Corsa 1855C Saint-Gobain SEKURIT DOT 215 ML61 SAI 43R-0030005.

After treatment with a composition including a polymer matrix, the glass surface was activated with Sika® Aktivator (commercially available from Sika Schweiz AG) and then an adhesive was applied to the cleaned glass ceramic surface. Triangular beads of the one-component, moisture-curing polyurethane adhesive SIKATACK®-MOVE GOES COOL (commercially available from Sika Schweiz AG) were applied in each case, using an extrusion cartridge and nozzle. The triangular beads were pressed down using polyethylene film (commercially available from Prodinger Verpackung AG, Switzerland).

The adhesive was tested after a cure time of 7 days storage in an environmental chamber (EC) (23° C., 50% relative air humidity).

The adhesion of the adhesive was tested using the “bead test” as described above.

TABLE 6
Composition including a polymer matrix and adhesion of adhesive
to a glass ceramic surface cleaned with this composition.

| | | | | | | | Result of bead |
|---|---|---|---|---|---|---|---|
| | | | | | | | test after |
| | Polymer | | | | | | rubbing 20 |
| No. | matrix | | Solid additive | | A1110 | DBTL | times |
| 21 | 35 | g PP1 | 15 | g silica gel | | | 2 |
| 22 | 45 | g PP1 | 5 | g Aerosil 972 | | | 1 |
| 23 | 42.5 | g PP1 | 7.5 | g Aerosil 200 | | | 1 |
| 24 | 35 | g PP1 | 15 | g Bentone | | | 2 |
| 25 | 46.95 | g PP2 | 2.5 | g Aerosil 200 | 0.5 g | 0.05 g | 1 |
| 26 | 44.45 | g PP2 | 5 | g Aerosil 200 | 0.5 g | 0.05 g | 1 |
| 27 | 46.95 | g PP2 | 2.5 | g Aerosil 972 | 0.5 g | 0.05 g | 1 |
| 28 | 44.45 | g PP2 | 5 | g Aerosil 972 | 0.5 g | 0.05 g | 1 |
| 29 | 46.95 | g PP2 | 2.5 | g silica gel | 0.5 g | 0.05 g | 2 |
| 30 | 39.45 | g PP2 | 10 | g silica gel | 0.5 g | 0.05 g | 1 |
| 31 | 46.95 | g PP2 | 2.5 | g Bentone | 0.5 g | 0.05 g | 3 |

Table 6 shows that good adhesion to a glass ceramic surface occurs when, before application of the adhesive, the silicone contaminants in the area where the adhesive was to be used on the windshield were removed efficiently by treatment with a polymer matrix according to the invention. All traces of the silicone compound contaminants are preferably removed with the polymer matrix according to the invention.

Of course, the invention is not limited to the exemplary embodiments shown and described. It is understood that the above-indicated features of the invention can be used not only in the combination given in each case, but also in other modifications, combinations, and alterations or in isolation, without going beyond the scope of the invention.

1. A method of removing silicon-containing contaminants from a glass or glass ceramic surface comprising applying a composition to the glass or glass ceramic surface,
wherein the composition comprises:
a) at least one carrier; and
b) at least one of either silicic acid or silicate.

2. The method according to claim 1, wherein the carrier is a solvent.

3. The method according to claim 1, wherein the solvent is water.

4. The method according to claim 1, wherein the solvent is an organic solvent.

5. The method according to claim 1, wherein the carrier is a fibrous material.

6. The method according to claim 1, wherein the carrier is a polymer matrix.

7. The method according to claim 1, wherein the composition additionally includes at least one wetting agent, in particular an ethoxylated polysiloxane.

8. The method according to claim 1, wherein the composition additionally includes at least one adhesion promoter composition, selected from the group consisting of a silane compound and a titanate compound.

9. The composition according to claim 1, wherein the silicic acid or the silicate has a Mohs hardness less than 7.

10. The method according to claim 1, wherein the silicic acid is a pyrogenic silicic acid.

11. The method according to claim 1, wherein the silicic acid is a silica gel.

12. A method of cleaning a surface comprising applying pyrogenic silicic acid to the surface as a cleaning agent.

13. Method for bonding substrates comprising:
a) cleaning a surface of a first substrate using the composition of claim 1;
b) applying an adhesive to the surface of either the first or a second substrate;
c) bringing the surface of the substrate without the adhesive into contact with the adhesive which is placed on the other substrate; and
d) curing the adhesive.

14. The method of claim 13, wherein the surface of the first substrate is a glass or glass ceramic surface.

15. The method of claim 13, wherein between step a) and step b), the method includes another step a′) including applying an adhesion promoter composition to the surface of the first substrate.

16. A composition including at least one fibrous material and at least one of either silicic acid or silicate.

17. A composition according to claim 16, wherein the silicic acid is a pyrogenic silicic acid.

18. A composition comprising at least one solvent and at least one of either silicic acid or silicate,
wherein the composition does not include an organic polymer or prepolymer.

19. A composition according to claim 18, wherein the silicic acid is a pyrogenic silicic acid.

20. A composition according to claim 18, wherein the solvent is an organic solvent.

21. A Composition consisting of:
a) at least one solvent A in an amount w=100 wt. %−(x+y+z);
b) at least one adhesion promoter substance B, selected from among the group consisting of silane compounds and titanate compounds in an amount x, where x is the total weight of all the adhesion promoter substances B and x has a value from 0 to 10 wt. %;
c) at least one substance C, selected from the group consisting of silicic acid and silicate, in an amount y, where y is the total weight of all the substances C and y has a value from 0.001 to 15 wt. %; and
d) at least one additive D in an amount z, where z is the total weight of all additives D and z has a value from 0 to 5 wt. %;
wherein the weight percents w, x, y, and z are respectively relative to the total weight of the composition, and
x=0 when the solvent A is water.

22. A composition according to claim 21, wherein substance C is a pyrogenic silicic acid.

23. A composition according to claim 21, wherein the solvent A is an organic solvent.
